(19) United States
(12) Patent Application Publication
(10) Pub. No.: US 2015/0017882 A1
(43) Pub. Date: Jan. 15, 2015

(54) SYSTEMS AND METHODS FOR EXTENDING CUTTING TOOL LIFE

(71) Applicants: University of Florida Research Foundation, Inc., Gainesville, FL (US); TECHSOLVE, INC., Cincinnati, OH (US)

(72) Inventors: Hitomi Greenslet, Gainesville, FL (US); Anil K. Srivastava, Cincinnati, OH (US)

(21) Appl. No.: 14/381,889

(22) PCT Filed: Feb. 28, 2013
(86) PCT No.: PCT/US13/28225

§ 371 Date: Aug. 28, 2014

Related U.S. Application Data
(60) Provisional application No. 61/604,187, filed on Feb. 28, 2012.

(51) Int. Cl. B23Q 17/09; B24B 31/00

(52) U.S. Cl. CPC B23Q 17/0995; B24B 31/003
USPC 451/36; 451/113

(57) ABSTRACT

In one embodiment, a system for extending cutting tool life includes a vise, a jig provided in the vise adapted to hold or support a magnetic cutting tool insert, a magnet holder positioned above the jig that can be rotated, a magnet held in proximity to the jig by the magnet holder, and a mixture including abrasive particles that extends between the magnet and the jig, the mixture being supported by a magnetic field generated by the magnet, wherein when the magnet holder rotates, the magnet and the mixture of magnetic and abrasive particles rotate to finish a surface of the tool insert.

### CROSS-REFERENCE TO RELATED APPLICATION(S)

This application claims priority to co-pending U.S. Provisional Application Ser. No. 61/604,187, filed Feb. 28, 2012, which is hereby incorporated by reference herein in its entirety.

### NOTICE OF GOVERNMENT-SPONSORED RESEARCH

This invention was made with Government support under grant numbers CMMI-0758220 and CMMI-0855381, awarded by the National Science Foundation. The Government has rights in the invention.

### BACKGROUND

The significance of titanium alloys is found in their light weight, high strength-to-weight ratio, excellent corrosion resistance, good biocompatibility, and relatively low coefficient of thermal expansion. Moreover, titanium alloys can exhibit the same advantages even at elevated temperatures. These attributes lead to a wide range of applications, especially in aerospace engines and airframe components. On the other hand, some undesirable characteristics, such as low thermal conductivity and a chemical affinity with cutting tool materials and coatings, accelerate tool wear and create difficulties in machining titanium alloys.

Various approaches have been used to improve the machinability of titanium alloys and the life of cutting tools. These approaches include development and control of tool materials and geometries, coating methods and materials, process parameters, and coolant use. Although technologies are ever improving, an innovative method to achieve a significant extension of the tool life during high-speed machining is still needed.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a schematic view of a first embodiment of a system for extending cutting tool life.

FIG. 2 is a schematic view of a second embodiment of a system for extending cutting tool life.

FIG. 3 is an image of an experimental setup that was used to machine a tool insert.

FIG. 4 is a graph that plots surface roughness of magnetic abrasive finishing (MAF) processed tool insert surfaces.

FIG. 5 is a graph that plots changes in maximum flank wear as a function of time.

FIG. 6 is a graph that plots changes in cutting forces as a function of time.

FIGS. 7A and 7B are scanning electron microscope images of tool inserts after turning tests were conducted.

FIGS. 8A and 8B are scanning electron microscope images of the sides of chips.

FIGS. 9A and 9B are oblique plots of chip backside surfaces.

FIG. 10 is a graph that plots tool wear versus machining time for twelve different cutting edge tools.

FIG. 11 is a flow diagram of a method for extending cutting tool life using MAF.

### DETAILED DESCRIPTION

As described above, it would be desirable to have a way to extend tool life during high-speed machining. Disclosed herein are systems and methods that achieve that result. In some embodiments, tool surfaces, for example carbide tool surfaces, are conditioned using magnetic abrasive finishing (MAF) to improve the tool wear characteristics by reducing friction between the tool and the workpiece. The configuration of the magnetic particle chains that drive the abrasive plays an important role in surface finishing with minimal damage to the tool cutting edges. Roughness of less than 25 nm Ra on the flank and nose and less than 50 nm Ra on the rake of the tool insert can be achieved.

Various embodiments are described in the following disclosure. It is to be understood that those embodiments are example implementations of the disclosed inventions and that alternative embodiments are possible. All such embodiments are intended to fall within the scope of this disclosure.

In machining, a cutting tool mainly fails due to wear, which is typically attributed to high temperature at the tool-workpiece interface. Reducing friction between the tool and workpiece to encourage smooth material removal is a promising way to reduce the tool-workpiece interface temperature and thus slow down the tool wear rate. It has been shown that structuring or texturing surfaces of cutting tool inserts improves their tribological properties. For example, reducing rake friction and improving the chip compression factor and normal forces increases tool life. This approach can also be realized by simply smoothing the tool surfaces while maintaining sharp cutting edges.

Disclosed herein is the application of MAF, in which magnetic abrasive or magnetic particles mixed with abrasive smooth the surface while following the tool form to condition tool surfaces. Described below are MAF processing principles, magnetic particle behaviors, and finishing characteristics. Also described are turning experiments using a rod of Ti-6Al-4V alloy, the most widely used Ti alloy in aerospace applications, used to evaluate the effects of MAF processing on tool life.

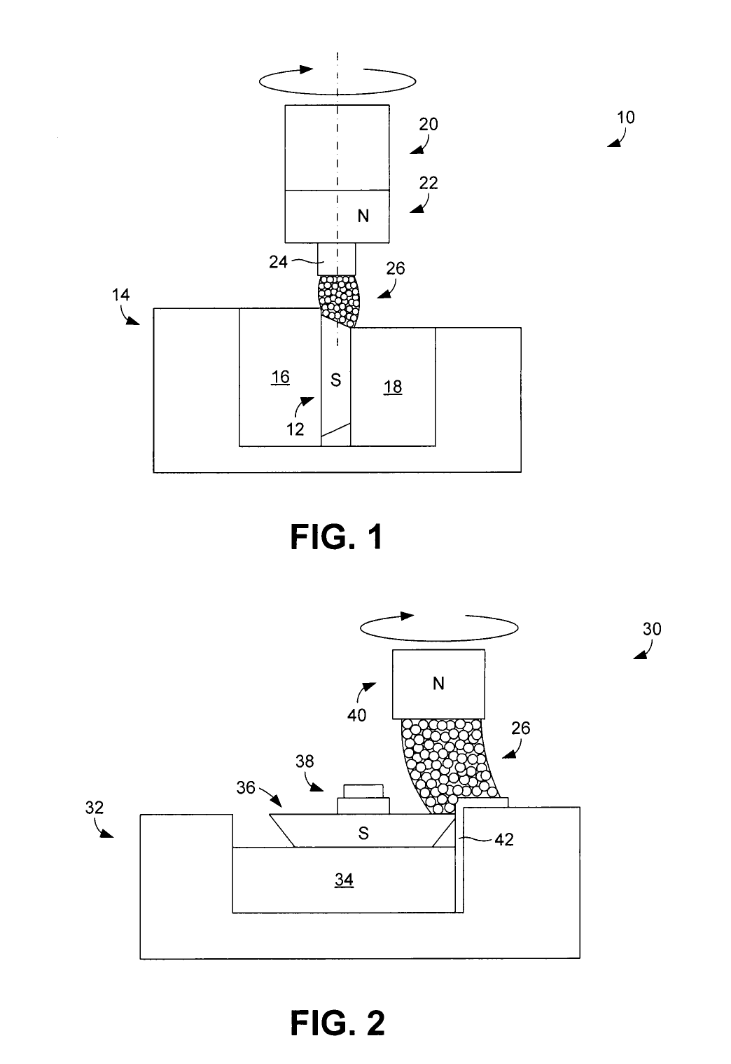

FIG. 1 shows a schematic of an example MAF process for triangular tool inserts. A mixture of magnetic particles and abrasive introduced between the pole tip (N) and cutting insert (S) are linked by magnetic force along the lines of magnetic flux. The magnetic force is transferred to the target area as finishing force. In a non-uniform magnetic field, the magnetic force F acts on a magnetic particle as shown in Eq. (1),

F=V_{X}H·gradH (1)

where V is the volume of the magnetic particle, _{X} is the susceptibility, and H and gradH are the intensity and gradient of the magnetic field, respectively. When the pole tip is rotated and translated, the mixture of magnetic particles and abrasive suspended by magnetic force moves with the pole tip while conforming to the target surface. The relative motion of the abrasive against the target surface achieves the finishing action and enables the finishing operation to be applied to not only flat surfaces (e.g., flank and rake faces) but also complex surfaces (e.g., tool nose). If needed, the workpiece can be rotated about the x-axis to align the nose with the z-axis.

Fine control of the stiffness, distribution, and motion of the magnetic particles permits precise control of the abrasive motion against the target surface and potentially enables micro- and nano-scale surface finishing. The magnetic circuit can be configured differently depending on the tool insert material (carbide, ceramic, etc.) and finishing target (flank, rake, or nose) to obtain an appropriate magnetic particle distribution. For example, to finish the flank face, it may be desirable for the magnetic particles to achieve the following conditions: (1) concentrate near the edge of flank face for finishing and (2) avoid flowing over the cutting edges back and forth to minimize rounding of the cutting edges. These conditions can be controlled by the mechanical and magnetic properties of the tool insert holder.

FIG. 1 shows an example system 10 in which MAF is used. In the example of FIG. 1, a tool insert 12 is securely held within a vise 14. In some embodiments the insert 12 is an uncoated carbide insert. In other embodiments, the insert 12 is coated with one or more layers of other material, such as titanium (Ti) or a Ti alloy. The insert 12 is held in place within the vise 14 with jigs 16 and 18 that are positioned on either side of the insert. In some embodiments, the jigs 16, 18 are made of a hard, nonmagnetic material, such as Ti or a Ti alloy. In other embodiments, the jigs 16, 18 are made of a hard magnetic material, such as carbon steel. As is shown in FIG. 1, the first jig 16 is taller than the second jig 18. In addition, the insert 12 has angled sides that are to be finished. The cutting edge of the top side of the insert 12 is positioned just below the top side of the first jig 16.

Positioned above the tool insert 12 and the vise 14 is a magnet holder 20 that can be rotated in the direction indicated by the circular arrow. The magnet holder 20 holds a strong magnet 22 that includes a pole tip 24 that can be positioned in close proximity to the insert 12. By way of example, the magnet 22 can be made of neodymium-iron-boron, alnico, samarium-cobalt, or ferrite and can generate a magnetic field having a strength of approximately 0.1 to 1.5 tesla, such as 0.2 tesla. Because the insert 12 is made of a magnetic material, a magnetic field is formed between the magnet 22 and the insert that can support a mixture 26 of magnetic and abrasive particles. In some embodiments, the magnetic particles are steel or iron particles having a mean diameter of approximately 3 to 1,000 microns (μm), such as 700 μm. In some embodiments, the abrasive particles are diamond, aluminum oxide, silicon carbide, or boron carbide particles having a mean diameter of approximately 0.1 to 5 μm, such as 1 μm. The magnetic and abrasive particles can, in some embodiments, be suspended in a lubricant, such as an oil-based lubricant.

When the magnet holder 20 rotates, the magnet 22, the pole tip 24, and the mixture 26 are likewise rotated. As the mixture 26 rotates while in contact with the exposed surface of the tool insert 12, the exposed surface is finished. In embodiments in which the jigs 16, 18 are nonmagnetic, the magnetic particles concentrate on the insert surface and align with the lines of magnetic force. In some embodiments, an additional magnet or magnetic material can be placed under the tool insert 12 to strengthen the magnetic field and control the magnetic flux direction, which directly influences the magnetic particle configuration.

As mentioned above, the cutting edge of the tool insert 12 is positioned below the top side of the jig 16. This is to avoid undesired particle motion over the cutting edge. Moreover, the jig 16 can be made of a material that is hard enough to resist being machined by the abrasive while the flank surface is being finished. If the jig is made of soft material, the abrasive preferentially machines the jig around the tool insert cutting edges. This might result in magnetic particle flow over the tool insert cutting edge, rounding the edge. Accordingly, in some embodiments, the jig 16, especially adjacent to the cutting edge, is made of a hard, nonmagnetic material, such as a titanium alloy.

The system 10 can also be used for nose finishing. The only difference is the tool insert orientation. In such finishing, the nose is positioned under the pole tip to create magnetic particle chains between the nose (the finishing target) and the pole tip.

FIG. 2 shows a system 30 that can be used for rake finishing. The rake region is cuspidate, and the cutting edge geometry should be protected from damage during surface finishing. As is shown in FIG. 2, the system 30 includes a vise 32 in which a jig 34 is positioned. A tool insert 36 is supported by the jig 34 and secured in place with a clamp 38. In addition, the system 30 includes a pole tip 40 of a magnet that can be rotated as indicated by the circular arrow.

The magnetic particles need to reach the edge of the rake face. However, to prevent damage, the particles should not flow over the cutting edge. To satisfy these requirements, the jig 34 can be made to be magnetic to concentrate the magnetic flux close to the cutting edge on the rake, and a cutting edge protector 42 can be placed between the tool insert 36 and the jig 34 or vise 32. In some embodiments, the cutting edge protector 42 is made of a compliant or elastic material, such as silicone rubber. When used, this protector 42 can conform closely to the cutting edge but should not interrupt the magnetic particle motion toward the edge of the rake.

In testing, a tool insert was held in a steel vise with silicone rubber (2 mm thick) clamping surfaces, and the tool insert edge was positioned lower than the top of the jig. The magnetic particle chains conformed to the geometry of the rake and cutting edge protector to finish the rake face-up to the edge. The rake geometry and protector constrained the particle motion and prevented the magnetic particles from flowing over the cutting edges.

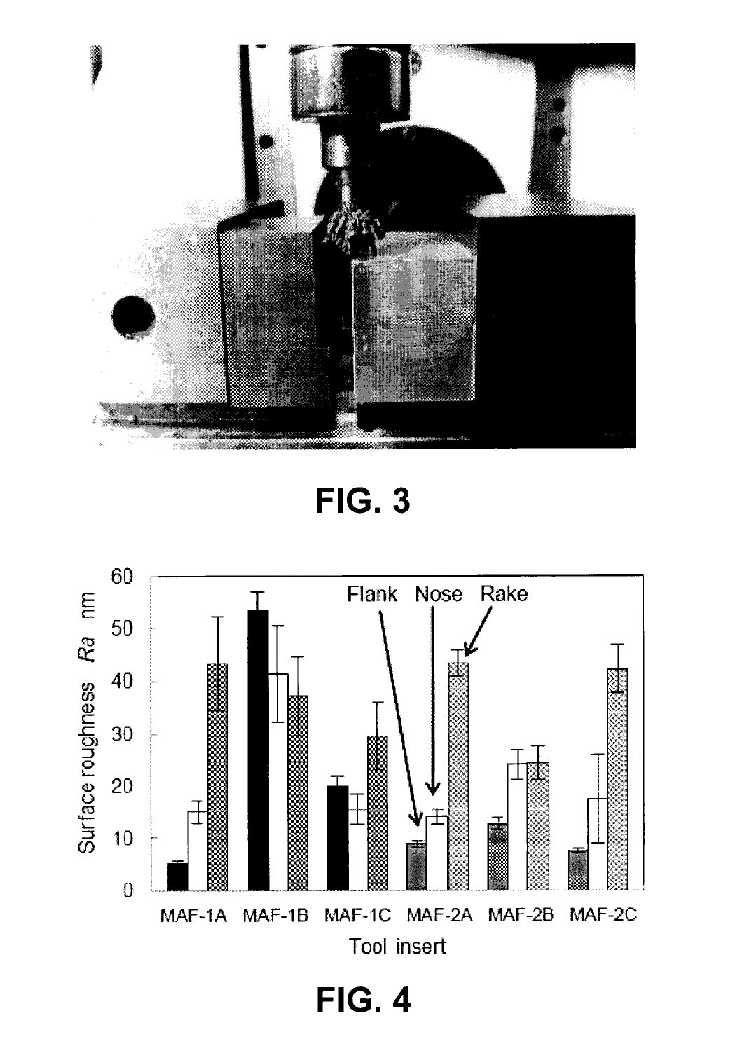

The principles shown in FIGS. 1 and 2 were tested using a 5-axis high-speed machining center shown in FIG. 3 for finishing the flank, rake, and nose of commercially-available, uncoated triangular carbide inserts (WC/Co grade, TPGN220408). The carbide tool insert included Co (3-7 wt %) and exhibited weak magnetism. Three neodymium permanent magnets (Ø25.4×12.7 mm, residual flux density 1.26-1.29 T; coercive force >875 AT/m) were mounted to the end of a magnet holder, and the holder was chucked in the spindle. To control the magnetic flux density at the finishing area, a steel pole tip was attached to the magnet.

Four triangular tool inserts (MAF-1 through MAF-4) were finished in the experiments, and two inserts (UP-1 and UP-2) were left unpolished. The corners of each insert were designated by a letter: MAF-1A, UP-2B, etc. The surface roughness at the flank, rake, and nose were measured using an optical profiler with a lateral resolution of 275.7 nm and a vertical resolution of <0.1 nm. A 100×100 μm area very close to the cutting edge at each corner was considered. The roughness Ra was calculated based on ten 100-μm-long profile lines. A Gaussian spline filter (band-pass mode) with a cut-off wavelength of 0.828 μm (high pass) and 14 μm (low pass) was applied. The measured initial surface roughness was 80-110 nm Ra on the flank and rake faces and 120-135 nm Ra on the nose.

The experimental conditions are shown in Table 1. Diamond abrasive mixed with lubricant was used, and only the abrasive sandwiched between the insert surface and magnetic particles performed the finishing action. According to Eq. (1), the magnetic force increases as the particle size (i.e., volume) increases; however, the increase in the volume reduces the packing density of the particles, thus reducing the abrasive available for finishing. To increase the amount of abrasive involved in finishing, a mixture of steel grit (700 μm mean diameter) and iron particles (44-105 μm diameter) was used to obtain a large magnetic force and trap more abrasive.

TABLE 1
Experimental Conditions

| Finishing target | Flank | Nose | Rake |
|---|---|---|---|
| Finishing time | 20 min | 15 min | 25 min |

| | | |
|---|---|---|
| Pole tip feed | 10 mm, 1 m/s | N/A |

| | |
|---|---|
| Spindle speed | 600 rpm |
| Gap between pole tip and target | 2 mm |
| Steel grits | 700 μm mean diameter, 0.3-0.5 g |
| Iron particles | 44-105 μm diameter, ~0.4 g |
| Abrasive | 0-1 μm diamond paste, 34 mg |
| Lubricant | Soluble-type barreling compound |
| | (pH 9.5, 755 mPa · s at 30° C.) |

FIG. 4 shows the surface roughness of the flanks, noses, and rakes of inserts MAF-1 and MAF-2 after finishing. Regardless of the initial surface conditions, the surface roughness was improved by the finishing process. The flank surface was improved to 5-20 nm Ra, the rake surface was improved to 10-45 nm Ra, and the nose surface was improved to 10-25 nm Ra. The conditions were set to finish the surface while tracing the as-received tool insert shape. The process removed the micro-asperities but left the grinding marks generated by the insert manufacturing process, which resulted in the deviation seen in the finished roughness (MAF-1B had high roughness values due to chipping caused by mishandling the tool insert during the finishing experiments). In the rake case, the particle configuration was restricted by the rake geometry and the rubber protector. This slowed down the material removal rate, and a longer finishing time was required for the rake than for the flank and nose. The surface roughness after finishing was higher on the rake than the other surfaces.

The effects of the finishing process on tool wear were next evaluated by turning a 50.8 mm diameter Ti-6Al-4V titanium alloy rod using the unprocessed and MAF-processed inserts. The turning tests were conducted using a CNC turning center interfaced with a computer and a three-dimensional dynamometer for force data acquisition. The cutting tool insert (5° rake angle) was fed into the workpiece at a feed rate of 0.075 mm/rev. The cut length per pass was 50 mm in the feed direction. The cutting speed was 100 m/min, and the depth of cut was 1.0 mm. A cutting fluid (Trim Sol: 5 vol. %) was supplied during the tests.

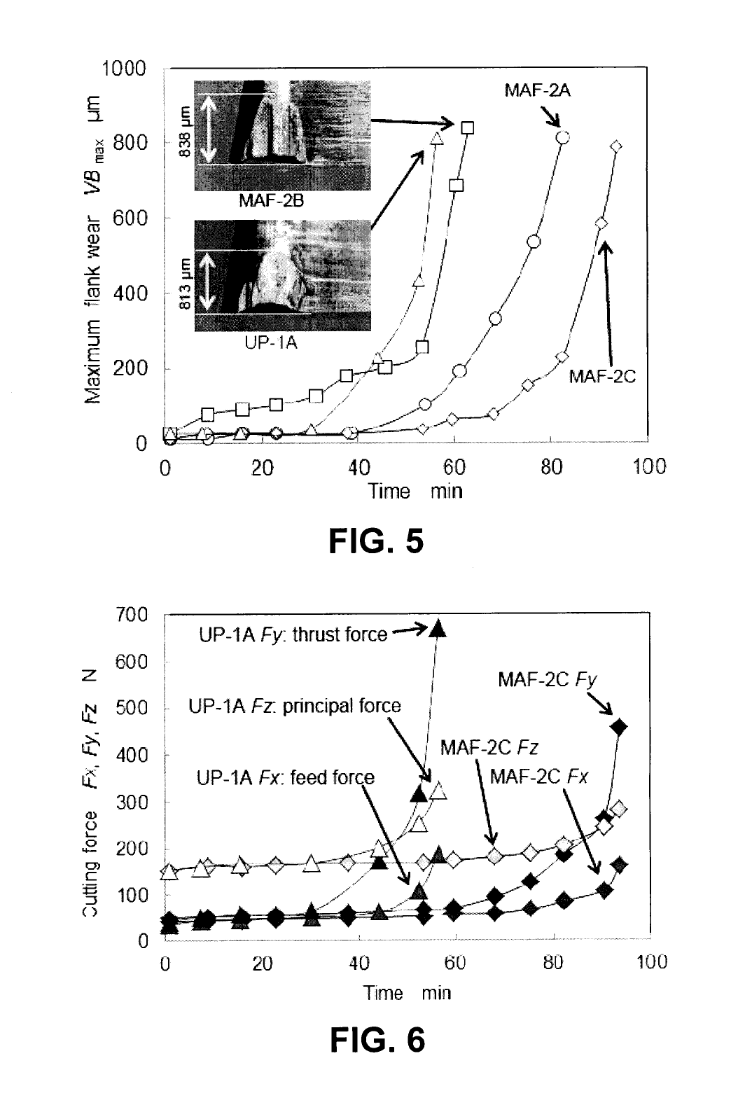

To evaluate the tool wear, images of tool flank were captured after every pass using an optical microscope connected to a digital camera and computer. The maximum flank wear (VBₘₐₓ) was measured through the digital images. For the experiments, the turning operation was terminated once VBₘₐₓ exceeded 762 μm. For example, the inset in FIG. 5 shows the tool insert UP-1A after 56.3 min (77 passes) when VBₘₐₓ was measured to be 813 μm and the experiment was stopped.

After the turning tests, the tool insert and chips (i.e., pieces of removed material) were observed with a scanning electron microscope (SEM) with energy dispersive spectroscopy (EDS). The chip backside surfaces (the surfaces in contact with the rake during cutting) were evaluated with an optical profiler.

FIG. 5 shows the measured maximum flank wear plotted after one pass, after every ten passes, and after final pass for the UP-1A and MAF-2 (A, B, and C). The figure shows that the MAF-processed tool inserts had useable tool lives up to twice as long as the unprocessed tool inserts. On MAF-2, the B corner exhibited the shortest tool life regardless of a smoothly finished rake (see FIG. 4). The MAF process might have damaged the cutting edges during the finishing process. Although the causes have not been determined, MAF-2B wore rapidly in the early stage, and VBₘₐₓ increased faster than with the other inserts. Eventually, tool breakage followed by severe crater wear on the rake ended the useable life of MAF-2B.

FIG. 6 shows representative changes in cutting force with time during turning tests using UP-1A and MAF-2C tool inserts. The tool wear is reflected in the thrust force, and as the tool wear progressed, the thrust forces exceeded the principal forces. The trends in cutting forces precisely correspond to the trends in VBₘₐₓ shown in FIG. 5.

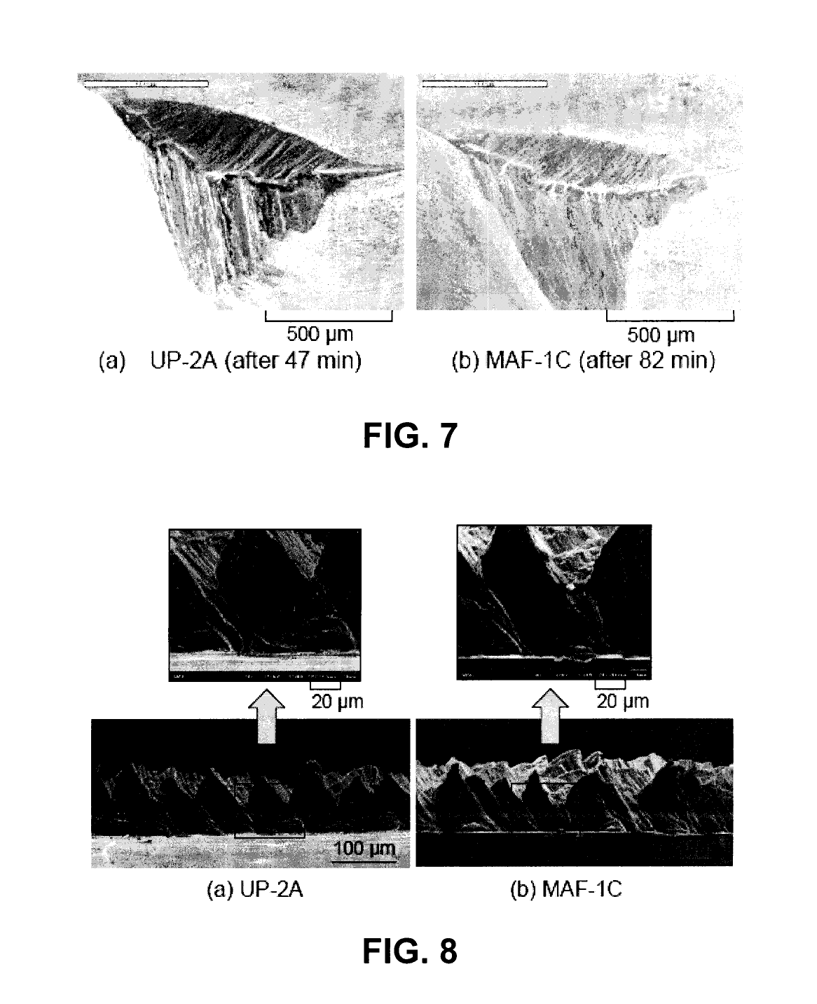

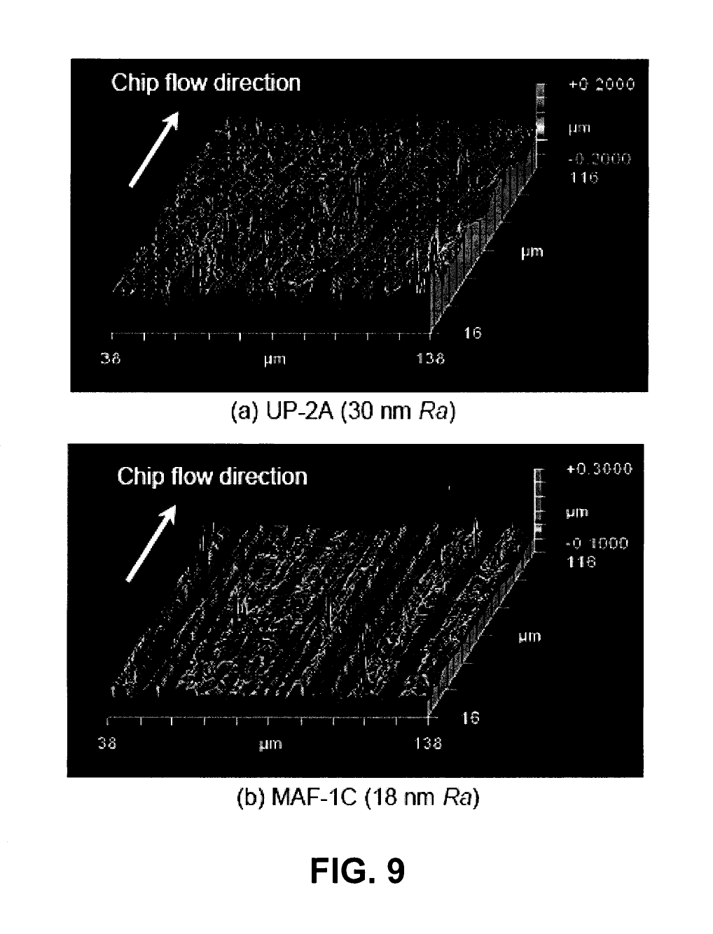

To observe the chip morphology, another set of turning tests was performed using UP-2 and MAF-1 tool inserts. MAF-1A and MAF-1C demonstrated longer tool lives (83 min and 73 min, respectively) than UP-2A (48 min). FIG. 7 shows SEM images of UP-2A and MAF-1C after the tests showing crater wear and heat-affected zones. In addition, EDS could detect neither tungsten nor cobalt on the worn sections of the flank, suggesting that workpiece material adhered to the worn tool sections. Serrated chips, which are typically observed in Ti-6Al-4V alloy machining, are seen in both cases in FIG. 8, but the chip formed by MAF-1C shows a slightly higher shear angle than the one formed by UP-2A. FIG. 9 shows oblique plots of the chip backside surfaces. The chip backside surface formed by MAF-1 C is smoother than the one formed by UP-2A. During turning with MAF-1C, the smoothly finished rake enabled the chip to flow with less friction. This confirms the causal relationship between the rake surface condition, friction between the rake and chip, and tool life.

The results of the above-described experimentation revealed that, regardless of initial surface conditions, roughness less than 25 nm Ra on the flank and nose and less than 50 nm Ra on the rake can be achieved. The MAF-processed surface improves tribological properties, reduces the friction of the chip against the rake, and results in extended tool life. In turning of Ti-6Al-4V alloy rods, MAF-processed tools had tool lives of up to twice as long as unprocessed tools.

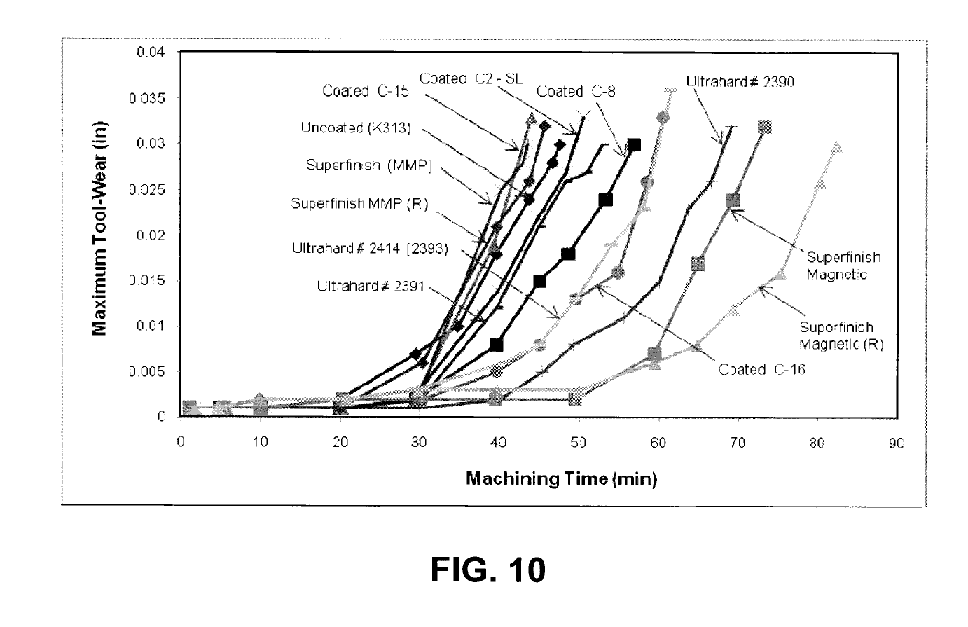

In further experimentation, MAF-processed-tool inserts were compared to coated carbide tool inserts. The results of this experimentation are shown in FIG. 10, which plots tool wear versus machining time for various cutting edge tools.

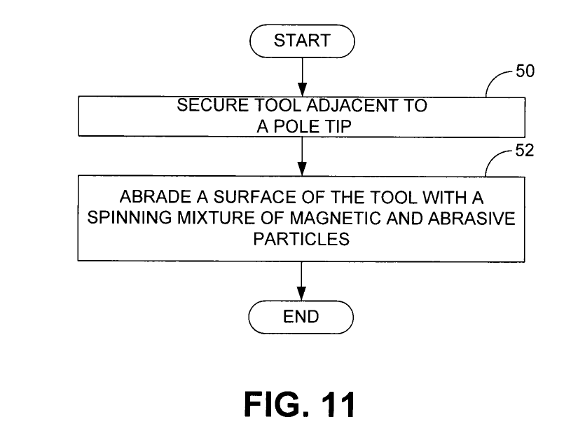

FIG. 11 illustrates an embodiment of a method for extending the cutting tool life that is consistent with the above disclosure. Beginning with block 50, a tool is secured adjacent to a rotatable pole tip of a MAF machine. As described above, the tool can comprise a tool insert that can be made of a hard material, such as carbide. In some embodiments, the tool insert is uncoated. In other embodiments, the tool insert is coated with one or more layers of other material, such a Ti or a Ti alloy. As is also described above, the tool can be secured in a jig, which can be made of a nonmagnetic material (e.g., Ti or a Ti alloy) or a magnetic material (e.g., carbon steel). In some embodiments, the tool is positioned within the jig so that the nose or other cutting edge of the tool is positioned below the top surface of an adjacent portion of the jig.

Once the tool has been secured, a surface of the tool is abraded with a spinning mixture of magnetic and abrasive particles, as indicated in block 52. In some embodiments, the mixture is spun using the pole tip of a magnet that is rotated by a spindle that has a speed range of approximately 0 to 6,000 rpm, for example 600 rpm. In some embodiments, the magnet is a neodymium-iron-boron, alnico, samarium-cobalt, or ferrite magnet that generates a magnetic field having a strength of approximately 0.1 to 1.5 tesla, for example 0.2 tesla. In some embodiments, the magnetic particles are steel or iron particles that have a mean diameter of approximately 3 to 1,000 μm, for example 700 μm. In some embodiments, the abrasive particles are diamond, aluminum oxide, silicon carbide, or boron carbide particles that have a mean diameter of approximately 0.1 to 5 μm, for example 1 μm. Irrespective of their composition and size, the magnetic and abrasive particles can be suspended in a lubricant, such as an oil-based lubricant.

Abrading continues until a desired level of finish is attained. In some embodiments, abrading continues until the tool surface has a surface roughness of approximately 5 to 60 nm Ra. In some cases, a cutting edge protector (e.g., a silicone rubber protector) can be placed between the tool insert and the jig to protect a sharp edge of the insert.

1. A system for extending cutting tool life, the system comprising:
a vise;
a jig provided in the vise adapted to hold or support a magnetic cutting tool insert;
a magnet holder positioned above the jig that can be rotated;
a magnet held in proximity to the jig by the magnet holder; and
a mixture including abrasive particles that extends between the magnet and the jig, the mixture being supported by a magnetic field generated by the magnet;
wherein when the magnet holder rotates, the magnet and the mixture of rotate to finish a surface of the tool insert.

2. The system of claim 1, wherein the jig is nonmagnetic.

3. The system of claim 2, wherein the jig is made of titanium or a titanium alloy.

4. The system of claim 1, wherein the jig is magnetic.

5. The system of claim 4, wherein the jig is made of carbon steel.

6. The system of claim 1, wherein the magnet comprises a pole tip that extends toward the jig.

7. The system of claim 1, wherein the magnet is made of one or more of neodymium, alnico, samarium, cobalt, and ferrite.

8. The system of claim 1, wherein the magnet generates a magnetic field having a strength of approximately 0.1 to 1.5 tesla.

9. The system of claim 1, wherein the mixture further includes one or both of steel particles and iron particles.

10. The system of claim 1, wherein the abrasive particles include one or more of diamond, aluminum oxide, silicon carbide, and boron carbide particles.

11. The system of claim 1, wherein the abrasive particles are suspended in an oil-based lubricant.

12. The system of claim 1, further comprising a cutting edge protector provided in the vise that is adapted to protect a cutting edge of the tool insert.

13. The system of claim 12, wherein the cutting edge protector is made of a compliant or elastic material.

14. A method for extending cutting tool life, the method comprising:
abrading a surface of a tool insert with a spinning mixture of abrasive particles that are suspended in a lubricant.

15. The method of claim 14, wherein abrading a surface of a tool insert comprises spinning the mixture with a spinning magnet.

16. The method of claim 15, wherein the mixture spins at a speed in the range of approximately 0 to 6,000 revolutions per minute.

17. The method of claim 14, wherein the mixture further includes one or both of steel particles and iron particles.

18. The method of claim 14, wherein the abrasive particles include one or more of diamond, aluminum oxide, silicon carbide, and boron carbide particles.

19. The method of claim 14, wherein the lubricant is an oil-based lubricant.

20. The method of claim 14, further comprising protecting a cutting edge of the tool insert using a compliant or elastic cutting edge protector.
